(19) United States
(12) Patent Application Publication
(10) Pub. No.: US 2013/0106345 A1
(43) Pub. Date: May 2, 2013

(54) CHARGER FOR REDUCING STATIC POWER CONSUMPTION

(71) Applicants: ZHEN-SEN LI, Shenzhen City (CN); JIAN-SHE SHEN, Shenzhen City (CN)

(72) Inventors: ZHEN-SEN LI, Shenzhen City (CN); JIAN-SHE SHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/585,750

(22) Filed: Aug. 14, 2012

(30) Foreign Application Priority Data
Oct. 28, 2011 (CN) 201110333530.4

(51) Int. Cl. H02J 7/02

(52) U.S. Cl. 320/107

(57) ABSTRACT

A charger for reducing static power consumption includes a switch unit, a voltage conversion unit, a detection unit, and a control unit. The switch unit is configured for controlling an AC input voltage supply for the voltage conversion unit. The voltage conversion unit is configured for converting the AC input voltage to a DC voltage to a load. The detection unit is configured for detecting an output current to the load. The control unit is configured for controlling the switch unit on or off based on the output current.

### BACKGROUND

1. Technical Field

The present disclosure relates to a charger for reducing static power consumption.

2. Description of Related Art

Portable electronic devices, such as mobile phones, personal digital assistants (PDA), are used widely all over the world. These portable electronic devices have individual batteries as corresponding energy storage elements for providing operation voltages to electrical components, such as displays and signal processors. In use, the portable electronic device can be connected to an external charger via a power line with connectors, so that the battery can be charged by the external charger. However, even if the electronic device is removed from the charger, the charger is still electrically connected to an alternating current (AC) external power. Therefore, the charger has static power consumption.

Therefore, a charger to overcome the above described shortcoming is desired.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of a charger according to an exemplary embodiment of present disclosure.

FIG. 2 is a circuit diagram of the charger of FIG. 1.

FIG. 3 is a schematic circuit diagram of a charger according to another exemplary embodiment of present disclosure.

### DETAILED DESCRIPTION

Reference will be made to the drawings to describe various embodiments in detail.

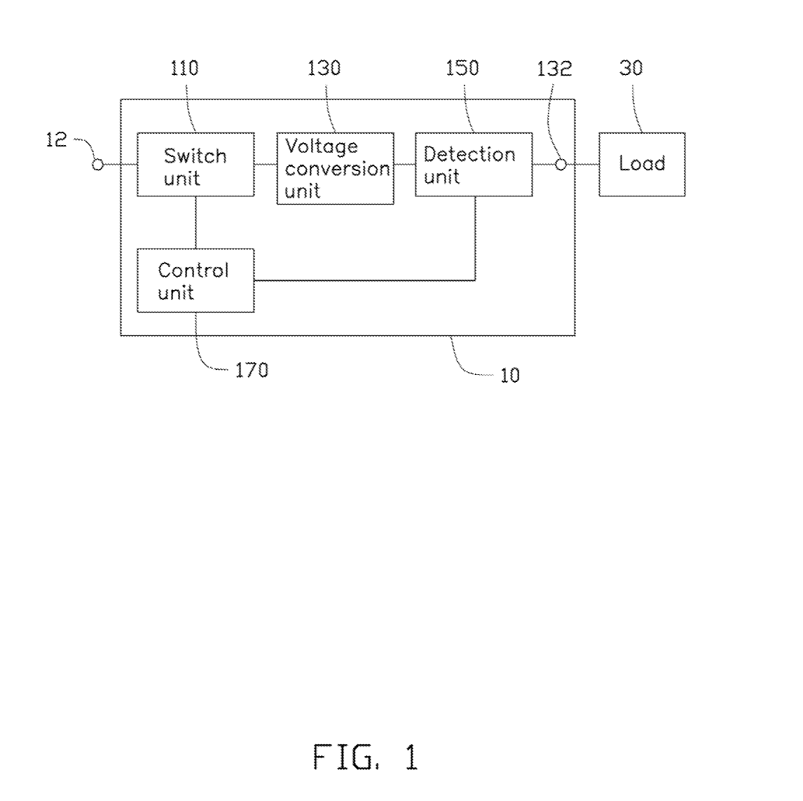

FIG. 1 illustrates a circuit block diagram of a charger 10 according to a first embodiment of present disclosure. The charger 10 can be, for example, configured for charging a load 30, such as a battery of a portable electronic device. The charger 10 includes a switch unit 110, a voltage conversion unit 130, a detection unit 150, and a control unit 170.

The switch unit 110 is electrically coupled to an AC voltage input terminal 12. The switch unit 110 is configured for controlling supply of an AC input voltage received by the terminal 12 for the voltage conversion unit 130. The voltage conversion unit 130 converts the received AC input voltage into a direct current (DC) voltage and outputs the DC voltage to the load 30 via an output terminal 132. The detection unit 150 is electrically connected to the output terminal 132 and is configured for detecting an output current flow through the output terminal 132. The control unit 170 is electrically connected to the detection unit 150 and the switch unit 110. The control unit 170 is configured for controlling the switch unit 110 to be on or off according to the output current.

In operation, when the switch unit 110 is turned on, the voltage conversion unit 130 receives the AC voltage input by the terminal 12 and converts the voltage into the DC voltage and outputs the DC voltage to the load 30 via the output terminal 132. The detection unit 150 detects the output current of the output terminal 132 and transmits a value of the output current to the control unit 170. When no current flows through the output terminal 132, the control unit 170 drives the switch unit 110 to be switched off. When current flows through the output terminal 132, the control unit 170 drives the switch unit 110 to be switched on.

In the embodiment, the switch unit 110 can be, for example, coupled between the load 30 and the AC power.

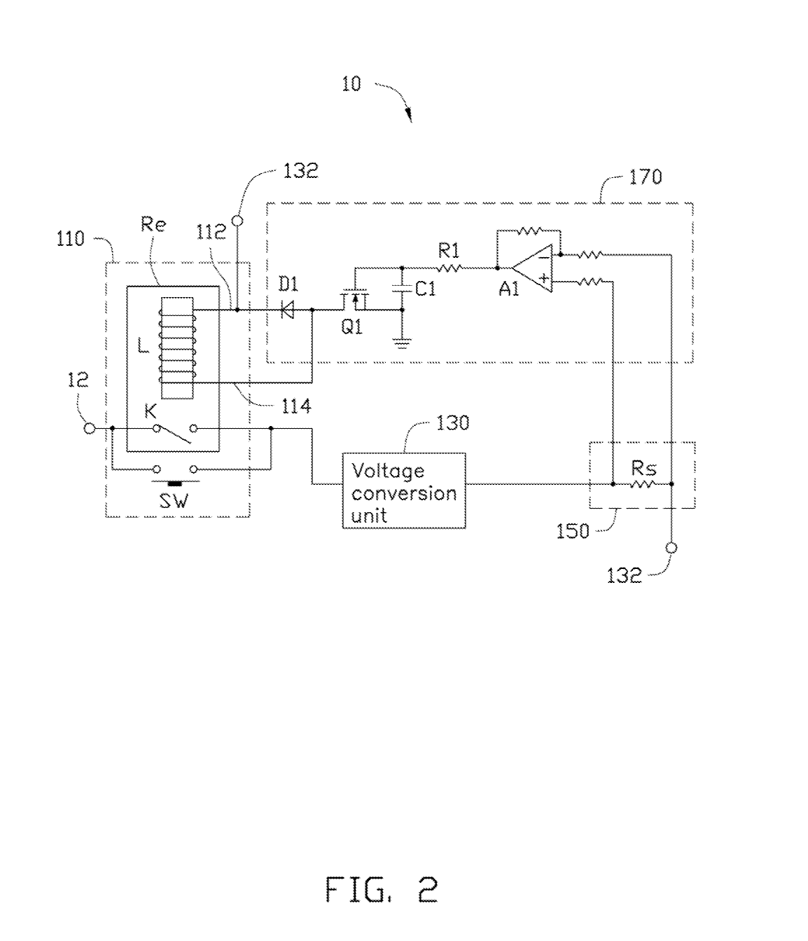

Referring also FIG. 2, the switch unit 110 of the embodiment is shown. The switch unit 110 includes a button switch SW and a relay Re connected in parallel. The button switch SW is in a normally off position and on when the button switch SW is pressed. The button switch SW is electrically connected to the terminal 12 and electrically connected to an input terminal of the voltage conversion unit 130. The relay Re includes a first switch K and an inductance L. The first switch K is electrically connected between the terminal 12 and to an input terminal of the voltage conversion unit 130. The inductance L includes a first terminal 112 and a second terminal 114. The first terminal 112 and the second terminal 114 both connect to the control unit 170. The first terminal 112 further connects to the output terminal 132.

The detection unit 150 includes a detection resistor Rs. The detection resistor Rs is electrically connected between an output terminal of the voltage conversion unit 130 and to the output terminal 132. The control unit 170 includes a comparator A1, a switch transistor Q1, a capacitor C1, a first resistor R1 and a diode D1. The switch transistor Q1 includes a control terminal, a first conducting terminal and a second conducting terminal. A positive input terminal of the comparator A1 is electrically connected to the detection resistor Rs via a resistor (not labeled). A negative input terminal of the comparator A1 is electrically connected to the detection resistor Rs. The negative input terminal of the comparator A1 is electrically connected to an output terminal of the comparator A1. The output terminal of the comparator A1 is electrically connected to the control terminal of the switch transistor Q1. The first conducting terminal of the switch transistor Q1 is grounded. An anode of the diode D1 connects to the second conducting terminal of the switch transistor Q1, a cathode of the diode D1 connects to the second terminal 114 of the inductance L.

In the embodiment, the switch transistor Q1 can be for example an N-channel enhancement mode metal-oxide-semiconductor field-effect transistor (N-MOSFET). The control terminal is a gate electrode of the N-MOSFET, the first conducting terminal is a source electrode of the N-MOSFET, and the second conducting terminal is a drain electrode of the N-MOSFET.

On one hand, when the button switch SW is pressed to be switched on, the current flows through the detection resistor Rs, so that a voltage potential difference generates between two ends of the detection resistor Rs. Therefore, amplitude of an input voltage of the positive terminal of the comparator A1 is greater than the amplitude of an input voltage of the negative terminal of the comparator A1, and then the output terminal of the comparator A1 outputs a logic high level signal to the control terminal of the switch transistor Q1. The switch transistor Q1 is switched on. A current on the output terminal 132 orderly flows through the first terminal 112, the second terminal 114 and the first and second conducting terminals of the switch transistor Q1 to the ground, so that the current flowing through the inductance L causes the first switch K to be switched on. Thus, the voltage conversion unit 130 can receive the AC voltage input by the terminal 12 via the first switch K and convert the AC voltage into the DC voltage. The DC voltage charges with the load 30.

When the load 30 is disconnected with the battery and the charger still receives the AC power, no current flows through the detection resistor Rs, so that the amplitude of input voltage of the positive terminal of the comparator A1 is substantially same as the amplitude of input voltage of the negative terminal of the comparator A1. Therefore, the output terminal of the comparator A1 outputs a logic low level signal to switch off the switch transistor Q1. No current is generated to flow through the inductance L, and the first switch K is switched off. A connection between voltage conversion unit 130 and the AC power is cut off.

In summary, when the load is removed, the relay Re may cut off the connection between the AC power and the voltage conversion unit 130. Therefore, the static power consumption is reduced.

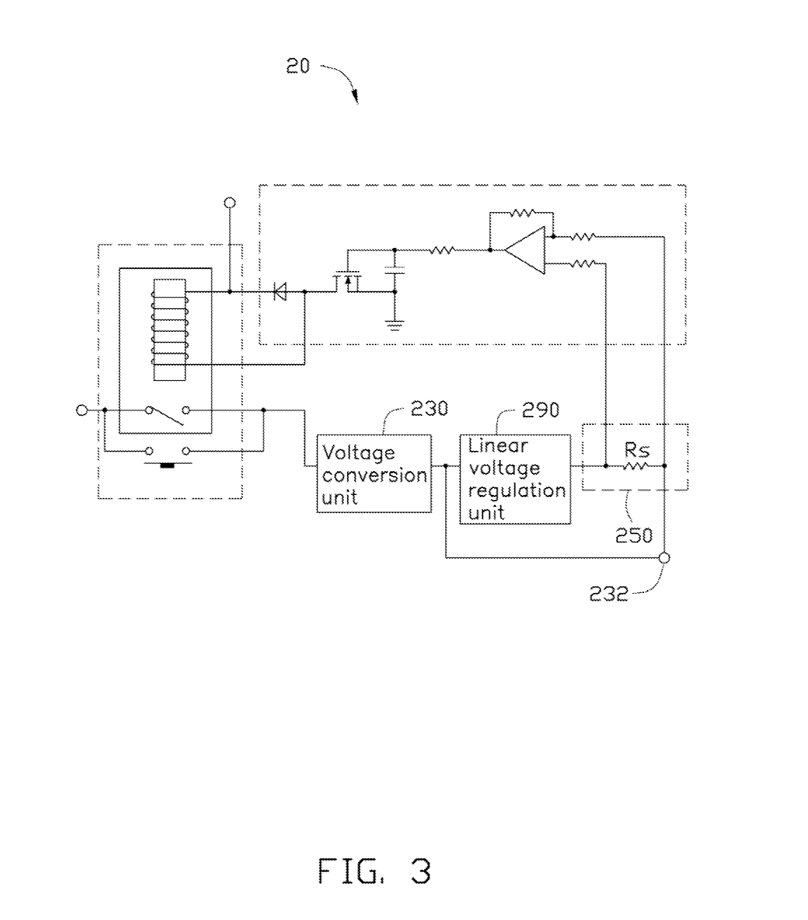

Referring to FIG. 3, a charger 20 according to another exemplary embodiment of present disclosure is shown. The charger 20 is similar to the charger 10; however, differences are the charger 20 further includes a linear voltage regulation unit 290. A first terminal of the linear voltage regulation unit 290 is electrically connected to a voltage conversion unit 230 and a second terminal of the linear voltage regulation unit 290 is electrically connected to a detection unit 250. The linear voltage regulation unit 290 is configured for providing a stable voltage for the detection unit 250.

It is to be understood that even though numerous characteristics and advantages of the present embodiments have been set forth in the foregoing description, with details of the structures and functions of the embodiments, the disclosure is illustrative only; and that changes may be in detail, especially in the matters of arrangement of parts within the principles of the embodiments to the full extent indicated by the broad general meaning of the terms in which the appended claims are expressed.

What is claimed is:

1. A charger, comprising:
a switch unit connected between an alternating current (AC) power configured for generating an AC input voltage and a voltage conversion unit configured for converting the AC input voltage into a direct current (DC) voltage;
an output terminal configured for outputting the DC voltage to a load;
a detection unit configured for detecting whether an output current is flowing through the output terminal; and
a control unit configured for controlling the switch unit to be switched on when the detection circuit detects that the output current is flowing through the output terminal, and to be switched off when no output current is flowing through the output terminal;
wherein when the switch unit is switched on, the charger receives and converts the AC voltages into the DC voltage, and applies the DC voltage to the load via the output terminal, and when the switch unit is switched off, the charger is disconnected with the AC power.

2. The charger of claim 1, wherein the switch unit comprises a button switch and a relay connected in parallel.

3. The charger of claim 2, wherein the button switch is in a normally off position and on when the button switch is pressed.

4. The charger of claim 3, wherein the relay comprises an inductance and a first switch connected in parallel with the button switch.

5. The charger of claim 4, wherein the inductance comprises a first terminal and a second terminal, the inductance connects to the control unit via the first terminal and the second terminal, and the first terminal connects to the output terminal.

6. The charger of claim 5, wherein the detection unit comprises a detection resistor, a first end of the detection resistor connects to the voltage conversion unit and a second end of the detection resistor connects to the output terminal.

7. The charger of claim 6, wherein the control unit comprises a comparator and a switch transistor; a positive terminal of the comparator connects to the first end of the detection resistor, a negative terminal of the comparator connects to the second end of the detection resistor; the switch transistor comprises a control terminal connecting to an output of the comparator, a first conducting terminal connecting to ground, and a second conducting terminal connecting to the first terminal of the switch unit.

8. The charger of claim 7, wherein the switch transistor is an N-channel enhancement mode metal-oxide-semiconductor field-effect transistor (N-MOSFET); the control terminal is a gate electrode of the N-MOSFET, the first conducting terminal is a source electrode of the N-MOSFET, and the second conducting terminal is a drain electrode of N-MOSFET.

9. The charger of claim 7, wherein the control unit further comprises a diode, an anode of the diode connects to the second conducting terminal of the switch transistor, a cathode of the diode connects to the second terminal of the inductance, and the second terminal of the inductance further connects to the second conducting terminal.

10. The charger of claim 1, the charger further comprises a linear voltage regulation unit, a first terminal of the linear voltage regulation unit is electrically connected to a voltage conversion unit and a second terminal of the linear voltage regulation unit is electrically connected to a detection unit, and the linear voltage regulation unit is configured for providing a stable voltage for the detection unit.

11. A power supply system, comprising:
a charger for charging a load through an output terminal of the power supply system, the charger comprising a switch unit, a voltage conversion unit, a detection unit, and a control unit;
wherein the voltage conversion unit converts an AC voltage into a DC voltage to the load; the detection unit comprises a detection resistor that detects an output current to the load; the control unit outputs a control signal to the switch unit based on the output current; the switch unit is switched on or off based on the control signal.

12. The power supply system of claim 11, wherein the switch unit comprises a button switch and a relay connected in parallel.

13. The power supply system of claim 12, wherein the button switch is in a normally off position and on when the button switch is pressed.

14. The power supply system of claim 13, wherein the relay comprises an inductance and a first switch connected in parallel with the button switch.

15. The power supply system of claim 14, wherein the inductance comprises a first terminal and a second terminal, the inductance connects to the control unit via the first terminal and the second terminal, and the first terminal connects to the output terminal.

16. The power supply system of claim 15, wherein the detection unit comprises a detection resistor, a first end of the detection resistor connects to the voltage conversion unit and a second end of the detection resistor connects to the output terminal.

17. The power supply system of claim 16, wherein the control unit comprises a comparator and a switch transistor; a positive terminal of the comparator connects to the first end of the detection resistor, a negative terminal of the comparator connects to the second end of the detection resistor; the switch transistor comprises a control terminal connecting to an output of the comparator, a first conducting terminal connecting to ground, and a second conducting terminal connecting to the first terminal of the switch unit.

18. The power supply system of claim 17, wherein the switch transistor is an N-MOSFET; the control terminal is gate electrode of the N-MOSFET, the first conducting terminal is source electrode of the N-MOSFET, and the second conducting terminal is drain electrode of N-MOSFET.

19. The power supply system of claim 17, wherein the control unit further comprises a diode, an anode of the diode connects to the second conducting terminal of the switch transistor, a cathode of the diode connects to the second terminal of the inductance, and the second terminal of the inductance further connects to the second conducting terminal.

20. The power supply system of claim 11, the charger further comprises a linear voltage regulation unit, a first terminal of the linear voltage regulation unit is electrically connected to a voltage conversion unit and a second terminal of the linear voltage regulation unit is electrically connected to a detection unit, and the linear voltage regulation unit is configured for providing a stable voltage for the detection unit.
